(19) United States
(12) Patent Application Publication
(10) Pub. No.: US 2023/0213074 A1
(43) Pub. Date: Jul. 6, 2023

(54) SPEED LIMITED ROTATIONAL MEMBER

(71) Applicant: ROTATIONAL SAFETY LLC, Ada, MI (US)

(72) Inventor: Brad GROENWOLD, Ada, MI (US)

(73) Assignee: ROTATIONAL SAFETY LLC, Ada, MI (US)

(21) Appl. No.: 17/356,587

(22) PCT Filed: Dec. 23, 2019
(86) PCT No.: PCT/US2019/068238

§ 371 Date: Jun. 24, 2021

Related U.S. Application Data
(60) Provisional application No. 62/784,858, filed on Dec. 26, 2018.

(51) Int. Cl. F16D 59/00; F16D 65/16; F16D 51/22; B65G 13/075

(52) U.S. Cl. CPC F16D 59/00; B65G 13/075; F16D 51/22; F16D 65/16; F16D 2121/14

(57) ABSTRACT

A speed limited rotational member including a first member, a second member rotatable relative to the first member, and first and second brake elements. The first and second brake elements are pivotally mounted to the first member for both pivoting between a first position spaced apart from a cooperating surface of the second member and a second position engaging the cooperating surface of the second member for generating friction to reduce a rotational speed of the rotational member. The speed limited rotational member further includes at least one linkage connecting the first and second brake elements. The speed limited rotational member may optionally include a down pressure component.

### CROSS-REFERENCE TO RELATED APPLICATION

This application is a continuation-in-part of PCT/US2019/068238 filed 23 Dec. 2019 which claims the benefit of U.S. Provisional Pat. Application No. 62/784,858 filed 26 Dec. 2018, now expired, which applications are herein expressly incorporated by reference.

### FIELD

The present disclosure relates to rotational members. The rotational members of the present disclosure may be used for including but not limited to conveyor systems, casters, wheels, gears, pulleys and any other applications including a rotational member. The present disclosure more particularly relates to speed limited rotational members for such applications.

### BACKGROUND

This section provides background information related to the present disclosure which is not necessarily prior art.

Various devices are provided with rotational members for increased mobility. For example, a conventional conveyor system may include rotational members in the form of rollers. Material handling carts, industrial carts, various vehicles, medical transportation devices, chairs may be conventionally provided with rotational members in the form of casters. Skateboards, roller skates, in-line skates, wheel chairs, walkers, shopping carts and the like may be conventionally provided with rotational members in the form of wheels.

It is generally desirable to reduce the rolling friction of rotational members for the ease of use and to improve overall performance. In some circumstances, however, it may be desirable to limit or dampen the rotation speed of such rotational members.

To a limited extent, certain arrangements for limiting or dampening the rotational speed of a rotational member are known. One such arrangement for limiting or dampening the rotational speed of a rotational members is shown and described in commonly owned U.S. Pat. No. 9,776,602. The speed limited wheel of U.S. Pat. No. 9,776,602 includes a three brake elements, for example. Each brake element defines a convexly curved friction surface and is independently coupled to a wheel main body and an overmold subassembly such that the brake elements each rotate with the wheel main body and overmold subassembly about a rotational axis of the wheel main body and overmold subassembly and may pivot about an axis parallel to the rotational axis of the wheel main body and overmold subassembly. As the rotational speed of the wheel increases, the brake elements are forced radially outward to engage a cooperating surface of the bushing/brake body and overmold subassembly. This engagement or rubbing produces friction that limits or dampens the rotational speed of the wheel. As the wheel rotates faster, the frictional force increases. U.S. Pat. No. 9,776,602 is hereby incorporated by reference as if fully set forth herein.

While known arrangements for limiting or dampening the rotational speed of rotational members may have proven to be suitable for their intended purposes, a continuous need for improvement exists.

### SUMMARY

This section provides a general summary of the disclosure, and is not a comprehensive disclosure of its full scope or all of its features.

According to a particular aspect, the present teachings provide a speed limited rotational member including a first member, a second member and first and second brake elements. The first and second brake elements are pivotally mounted to the first member for both pivoting between a first position spaced apart from a cooperating surface of the second member and a second position engaging the cooperating surface of the second member for generating friction to reduce a rotational speed of the rotational member. The speed limited rotational member further includes at least one linkage connecting the first and second brake elements.

According to another particular aspect, the present teachings provide a roller assembly for a conveyor system. The roller assembly includes a shaft, a first end cap, a puck, collar, spring stop, first and second brake elements, main body portion, a hub and at least one linkage. The first end cap is rotatably carried on the shaft. The puck is disposed in a recess of the first end cap and is rotatable relative to the first end cap. The puck has a central opening through which the shaft passes. The central opening allowing the puck to rotate relative to the shaft. The first and second brake elements are pivotably mounted to the puck. The first and second brake elements both pivot between a first position and a second position. The hub circumferentially surrounds the first and second brake elements. The hub is connected / stationary to the shaft. The at least one linkage connects the first and second brake elements. In the first positions, the brake elements allow free rotation of the hub about the shaft and in the second positions the brake elements frictionally engage the hub to reduce a rotational speed.

According to a yet another particular aspect, the present teachings provide a method of reducing a rotational speed of a rotational member. The method includes providing a cylindrical hub. The method additionally includes pivotally mounting first and second brake elements to a plate and linking the first and second brake elements with a linkage. The method further includes pivoting each brake element between a first position spaced apart from the cylindrical flange of the brake hub and a second position engaging the cylindrical flange of the brake hub generating friction to reduce a rotational speed of the rotational member.

Further areas of applicability will become apparent from the description provided herein. The description and specific examples in this summary are intended for purposes of illustration only and are not intended to limit the scope of the present disclosure.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

The drawings described herein are for illustrative purposes only of selected embodiments and not all possible implementations, and are not intended to limit the scope of the present disclosure.

FIG. 1 is an exploded view of a speed limited rotational member in accordance with the present teachings.

FIG. 2 is a longitudinal cross section of the speed limited rotational member of FIG. 1.

FIG. 3A is perspective view of an end cap of the speed limited rotational member of FIG. 1.

FIG. 3B is an end view of the end cap of FIG. 3A.

FIG. 4 is a linkage of the speed limited rotational member of FIG. 1.

FIG. 5A is perspective view of a hub of the speed limited rotational member of FIG. 1.

FIG. 5B is an end view of the hub of FIG. 5A.

FIG. 6 is an exploded end view of the optional down pressure reduction component of FIGS. 1 and 2.

FIG. 6A is an end view of the down pressure reduction component of FIG. 6.

FIG. 6B is a side view of the down pressure reduction component of FIG. 6.

FIG. 6C is an end view of the collar of FIGS. 1 and 2.

FIG. 7A is end view of a weight assembly of the speed limited rotational member of the present teachings, the weight assembly shown in a first operational state for permitting free rotation of the rotational member.

FIG. 7B is an end view of a weight assembly of the speed limited rotational member of the present teachings similar to FIG. 7A, the weight assembly shown in a second operational state for permitting dampening rotation of the rotational member.

FIG. 7C is a view similar to FIG. 7A shown with the linkages removed for purposes of illustration and shown with different weights and spring stop component.

FIG. 7D is a view of the brake elements of FIG. 7C with the linkages.

FIG. 8A is an exploded side view of an alternative hub assembly with down pressure reduction of the present teachings.

FIG. 8B is a longitudinal cross section of the hub assembly with down pressure reduction of FIG. 8A.

FIG. 9 is an exploded view of a speed limited wheel in accordance with the present teachings.

FIG. 10 is a cross-sectional view of the speed limited wheel of FIG. 9.

FIG. 11 is a perspective view of a subassembly of the speed limited wheel of FIG. 9 including an end cap, first and second weights and first and second sliding elements.

FIG. 12 is another perspective view of the subassembly of FIG. 10 with the external adjustable first and second sliding elements.

FIG. 13A is a perspective view of a modified end cap in accordance with the present teachings.

FIG. 13B is an end view of the end cap of FIG. 13A.

FIG. 14 is an end view of a modified brake element in accordance with the present teachings.

FIG. 15 is an end view of a modified collar of the present teachings.

FIGS. 16A-16E illustrates a series of views of a modified brake element in accordance with the present teachings.

FIGS. 17A-17E illustrates a series of views of a magnet housing in accordance with the present teachings.

Corresponding reference numerals indicate corresponding parts throughout the several views of the drawings.

### DETAILED DESCRIPTION

Example embodiments will now be described more fully with reference to the accompanying drawings.

The present application improves upon the teachings of U.S. Pat. No. 9,776,602. To the extend not otherwise described herein, it will be appreciated that details of exemplary applications incorporating the speed limited rotational member of the present teachings may be similar to corresponding details shown and described in U.S. Pat. No. 9,776,602.

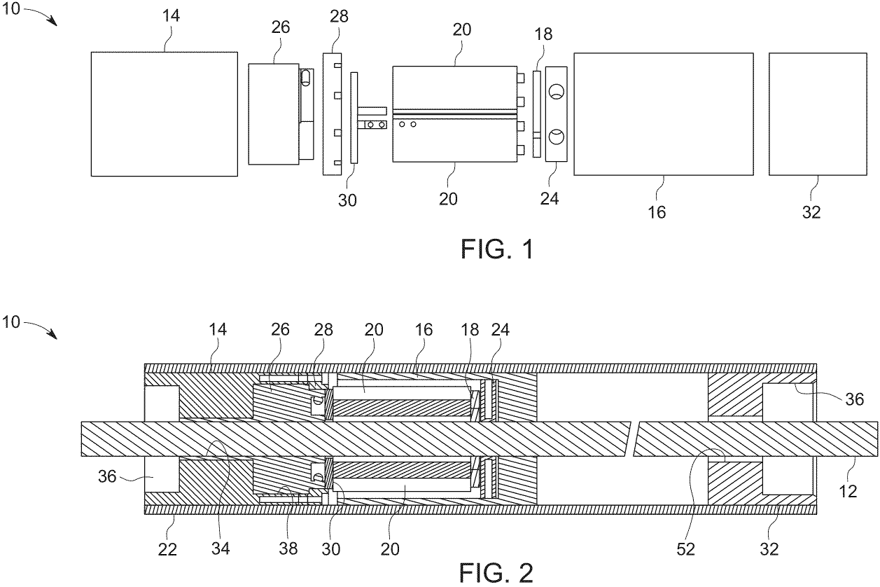

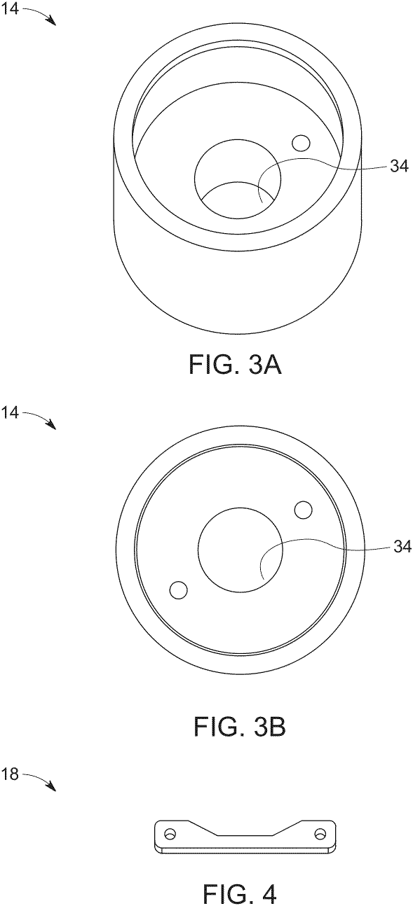

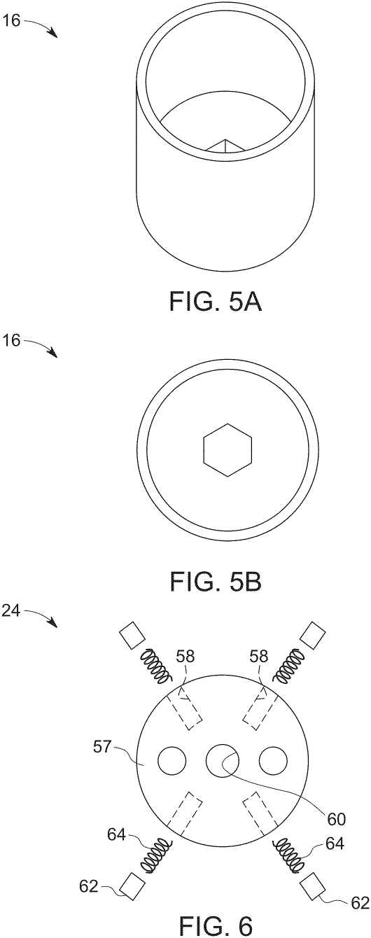

With initial reference to FIGS. 1 through 7D of the drawings, a speed limited rotational member in accordance with the present teachings is illustrated and generally identified at reference character 10. In the particularly embodiment illustrated, the present teachings are particularly adapted for a speed limited rotational member for a conveyor system. It will be understood, however, that the present teachings may be readily modified for other applications.

The speed limited rotational member 10 is generally shown to include a shaft 12, a first end cap with braking mechanism / housing 14, a hub 16, at least one linkage 18, first and second brake elements 20, an external roller tube 22, a puck 26, a collar 28, a spring stop 30, and a second end cap 32. The speed limited rotational member 10 is shown to optionally include a down pressure reduction assembly cooperatively defined by a down pressure reduction component 24, the puck 26 and the collar 28.

The end cap 14 is generally cylindrical in shape and includes a central opening 34 through which the shaft 12 passes. The shaft 12 may have a hexagonal cross section. At one end, the end cap 14 defines a recess 36 for receiving a first bearing (now shown). The first bearing may include an inner race non-rotatably receiving the shaft 12 and an outer race that permits the end cap 14 to rotate relative to the shaft 12. At an opposite second end, the end cap 14 defines a cylindrical recess 38 that rotatable receiving the puck 26. The collar 28 holds the puck 26 in the recess 38.

The hub 16 has an opening that receives the shaft 12. In the embodiment illustrated, the opening is hexagonal such that the shaft 12 is non-rotatable received by the hub 16.

The end cap 32 includes a central opening 52 that rotatable receives the shaft 12. The end cap 32 defines a recess 36 for receiving a second bearing (now shown). The second bearing may include an inner race non-rotatably receiving the shaft 12 and an outer race that permits the end cap 32 to rotate relative to the shaft 12.

As will be addressed herein, the first and second brake elements 20 normally allow the external roller tube 22 to rotate freely about the shaft 12 and engage the hub 16 to slow this free rotation in response to an increase in rotational speed. The brake elements 20 may be constructed of plastic and may carry a plurality of metal weights 40. The brake elements 20 are arch-shaped and include a first end 42 pivotably coupled to the puck 26. In the embodiment illustrated, a pin 44 attaches to the down pressure reduction component 24, through the brake element 20 and engages the puck 26. Those skilled in the art will appreciate that, in certain applications, the speed limited rotational member may be adapted to include a greater or lesser number of brake elements within the scope of the present teachings.

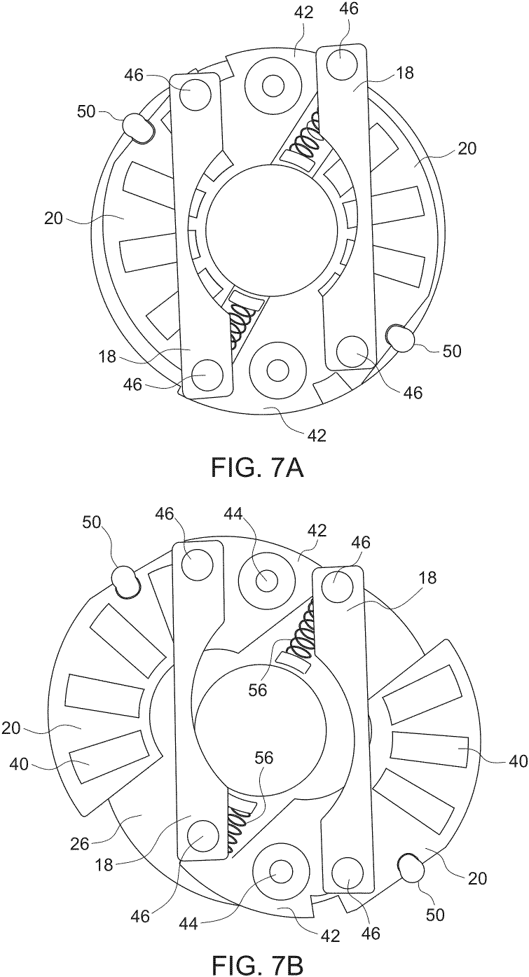

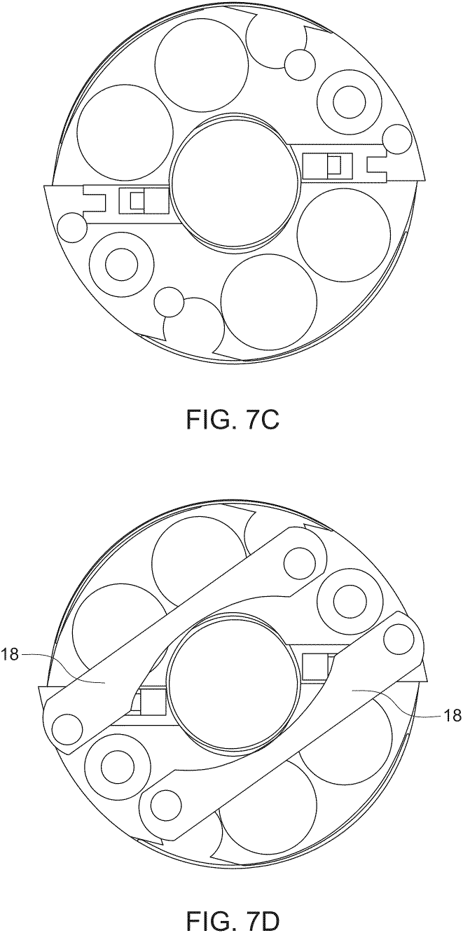

As perhaps best shown in the views of FIGS. 7A and 7B, at least one linkage 18 connects the first and second brake elements 20. Preferably, the first and second linkages 18 connect the first and second brake elements 20. The brake elements 20 may each carry or be formed to include first and second pins 46. The pins 46 of the brake elements 20 are received in opposite ends of the linkages 18. The linkages 18 operates to tie both brake elements 20 together. In this manner, the variable of gravity of the individual brake elements 20 as the brake elements 20 are rotated is eliminated. Explaining further, if the brake elements 20 are not coupled with the linkages 18, rotation of an individual weight over the top of the axle and back down may cause the weight to contact the non-spinning hub and thereby create a “pulsing” action of the brake. When the two weights are linked together, the top weight will goes up if the other weight goes down. Where the two weights are of equal mass, the bottom weight will not fall onto the non-spinning hub because of the link and “pulsing” is eliminated. The only way the weights will move radially outward is by centrifugal forces.

Each brake element 20 is shown to define a convexly curved surface. For example, these surfaces may be convexly curved surfaces for directly engaging cooperating surface of the hub 16, with or without a friction element 50, may carry a friction member having a greater coefficient of friction as compared to the surface. The friction member 50 may extend parallel to the axial direction and may engage the inner surface of the hub 16. In the embodiment illustrated, the friction members 50 may be constructed with suitable material.

As the rotational speed of the external roller tube 22 increases, the brake elements 20 are forced radially outward from a first position (as shown in FIG. 7A) to a second position (as shown in FIG. 7B). In the first position, the external roller tube 22 is allowed to freely rotate. In the second position, rotation of the external roller tube is slowed. Explaining further, the frictional members 50 engage the inner surface of the hub 16. This engagement or rubbing produces friction that limits or dampens the relative rotational speed. As the external roller tube 22 rotates faster, the frictional force increases.

The size of the weights 40 and the location of the contact points of the friction elements 50 to the hub 16 contribute to the amount of brake force applied. The friction elements 50 may be of different materials to achieve a desired coefficient of friction. In addition, while not required for particular application, springs 56 may be employed to further determine how much braking force is applied and when the braking force is applied. Such springs are further shown and described in U.S Pat. No. 9,776,602. In addition to effecting the strength of the brake force, such springs 56 may be incorporated to allow the rotational device to have a “free spin” (e.g., no braking engagement of the braking elements with the hub) at low rotational speeds, for example. As shown particularly in FIG. 7C, the springs may be connected at first ends to pegs carried by the brake elements 20 and at second ends to pegs carried by the puck 26.

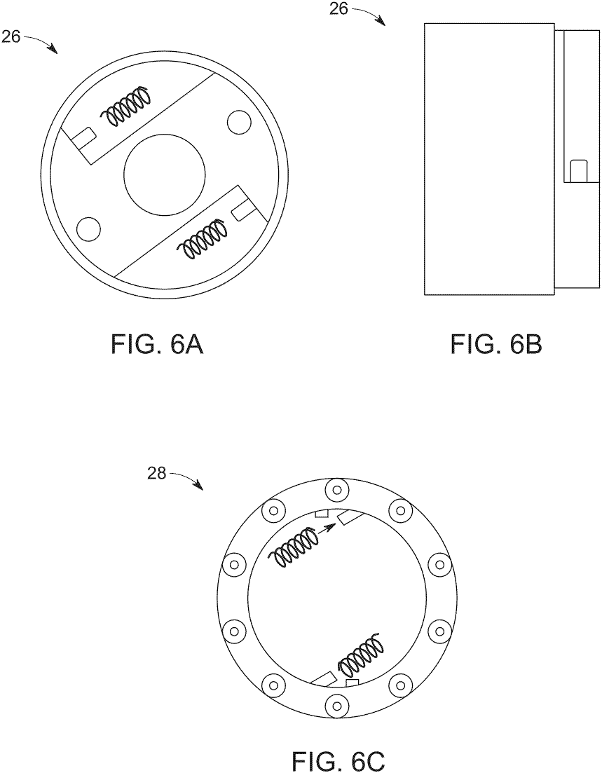

The collar 28 is fixed for rotation to the end cap 14 and secures the puck 26 rotatably within the end of the end cap 14. As will be discussed below, the collar may alternatively be fixed to the hub 16 to secure the puck 26 rotatably within the hub 16. The puck 26 is allowed to rotate freely but is securely within the end cap 14 (or hub 16) in order to support the braking elements 20 and the main body portion 57. As shown particularly in FIG. 6C, the collar 28 has at least peg to receive one end of a spring. The other end of the spring is connected to at least one peg of the puck 26. In the embodiment illustrated, the collar 28 and the puck 26 both include first and second pegs to cooperate with first and second springs. The springs function to bias the external roller tube 22 in a counter direction of the normal tube rotation to accomplish a reduction of down pressure of packages on the external roller tube.

The optional down pressure reduction assembly cooperatively defined by the down pressure reduction component 24, the puck 26 and the collar 28 cooperates with the brake elements 20 to create a backspin of the puck 26. The down pressure reduction component 24 is shown particularly in the exploded view of FIG. 6 and the additional views of FIGS. 6A and 6B. The down pressure reduction component 24 includes a main body portion 57 defining a plurality of radially extending holes 58 and a central opening 60. The central opening 60 rotatable receives the shaft 12. In the embodiment illustrated, the main body portion 57 defines four radially extending holes 58. Each hole 58 receives a friction element 62 and a spring 64. The springs 64 keep the friction elements 62 under a spring force that will keep the friction elements in constant contact with the inside of the hub 16 to activate/rotate the puck 26 inserted in the end cap 14, that is also under spring force. Once a package on the roller tube 22 of a conveyor is removed, the roller tube 22 will rotate back to a neutral position.

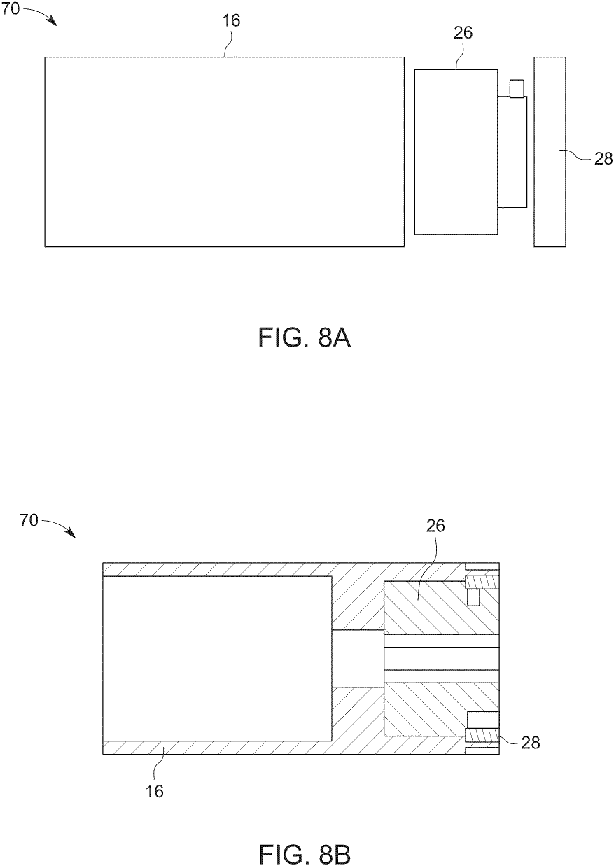

With reference to FIGS. 8A and 8B, an alternative hub assembly 70 in accordance with the present teachings is illustrated. In this alternative construction, the puck 26 is moved from the end cap 14 to the hub 16. The puck 26 can be designed within the end cap 14 with the braking mechanism or within the hub 16. When the brake mechanism and the main body portion 57 is engaged, it rotates the puck 26 up to the spring tension that the puck 26 is connected to. The other end of the spring is connected to the collar 28 or the hub 16.

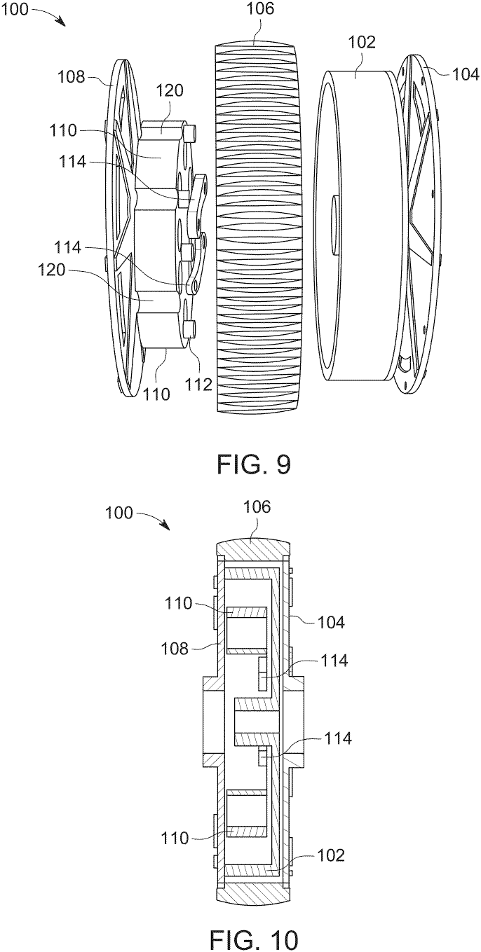

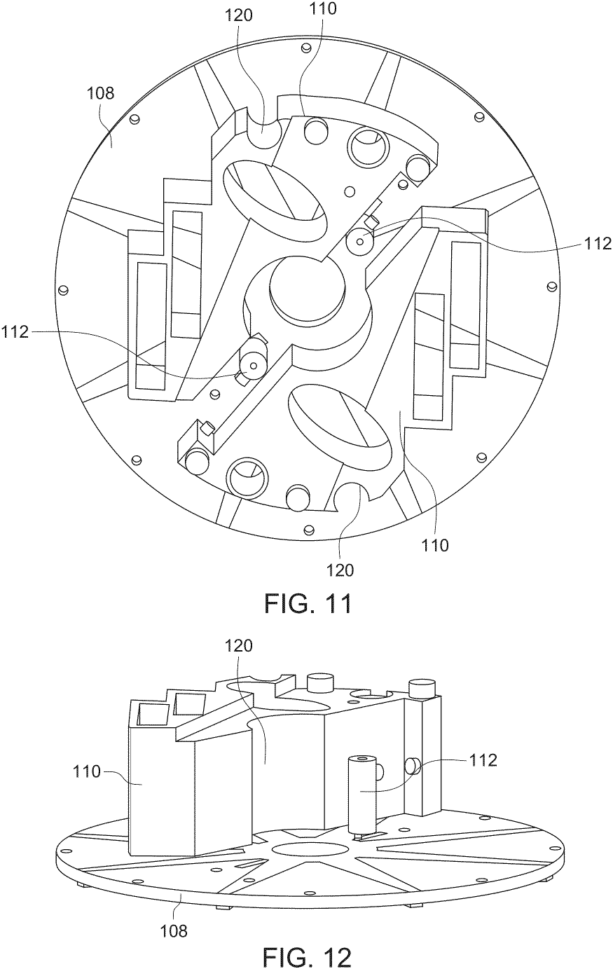

Turning to FIGS. 9 through 12, another speed limited rotational member in accordance with the present teachings is illustrated and generally identified at reference character 100. In the particularly embodiment illustrated, the present teachings are particularly adapted for a speed limited wheel. The speed limited wheel 100 is shown to generally include a hub 102, a first end cap 104, a rim and tire component 106, a second end cap 108, first and second weights 110, first and second sliding elements 112, and first and second linkages 114.

The brake elements 110 are similar in construction and function to the brake elements 110 of the speed limited rotational member 10. The brake elements 110 are pivotally coupled to the end plate 108 for movement between retracted positions and extended positions. As with the speed limited rotational member 10, when the brake elements 110 are in the retracted positions, the brake elements 110 do not contact the hub 102 and the wheel 100 freely rotates. In the extended positions, the brake elements 110 or a supplemental friction member carried by the brake elements 110 frictional engage the hub 102 to slow or stop rotation of the wheel 100.

The brake elements 110 are coupled to one another by the first and second linkages 114 such that the brake elements move in unison between the retracted and extended positions as the wheel rotates and as the RPMs of the wheel increases. This linkages 114 function to eliminate or substantially eliminate any adverse effect from gravity and thereby provide a more uniform braking performance.

The first and second brake elements 110 are associated with the first and second sliding elements 112, respectively. The sliding elements 112 are fixed to the end cap 108 but slidably adjustable relative to the corresponding brake elements 110. The sliding elements 112 enable the braking force of the first and second brake elements 110 to be adjustable externally. The sliding elements 112 are each attached to end of a corresponding spring. The other end of each spring is attached to the corresponding brake elements 110. The strength of the springs can be selected or the sliding elements 112 can be adjusted so as to change the compression of that spring. In this manner, the brake elements 110 can operate to brake all the time, not at all, and at selected rotational speeds in between. When the wheel increases RPMs, the brake elements 110 move toward their extended positions (e.g., protrude radially outward) due to centrifugal forces and cause the brake elements 110 to frictionally come into contact with the hub 102. This contact creates friction which thereby dampens the RPMs or rotational speed of the wheel 100.

The hub 102 does not rotate. In this regard, the hub 102 may be non-rotationally carried on an axle or non-rotationally compressed between inner races of two bearings (not specifically shown). The end cap 104 provides structural support for the wheel 100 and serves to enclose the internal components of the wheel 100. The end cap 108 similarly provides structural support for the wheel 100 and an enclosure for the internal components of the wheel 100. The rim and tire component 106 functions as structural support and carries material that is in contact with the surface the wheel 100 runs. Both end caps 104 and 108 are secured to the rim and tire 106.

In addition to the above described applications, the speed limited rotational member of the present teachings may be incorporated into virtually any application incorporating a rotational member. In addition to the particular applications described above, the present teachings may be readily adapted for applications including into a wheel or other rotational member with bearings or axel. An exemplary application of such an arrangement is shown and described in U.S. Pat. No. 9,776,602.

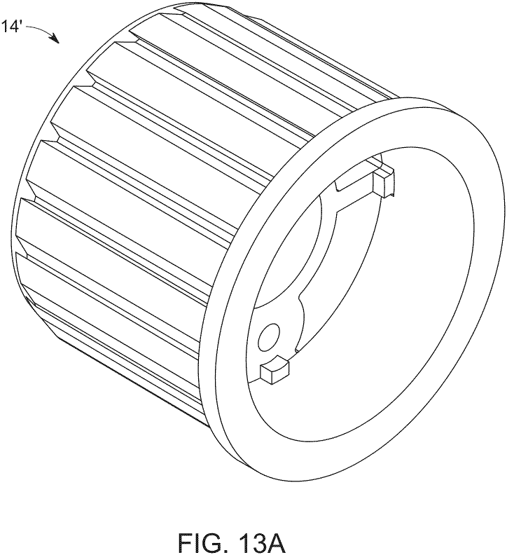

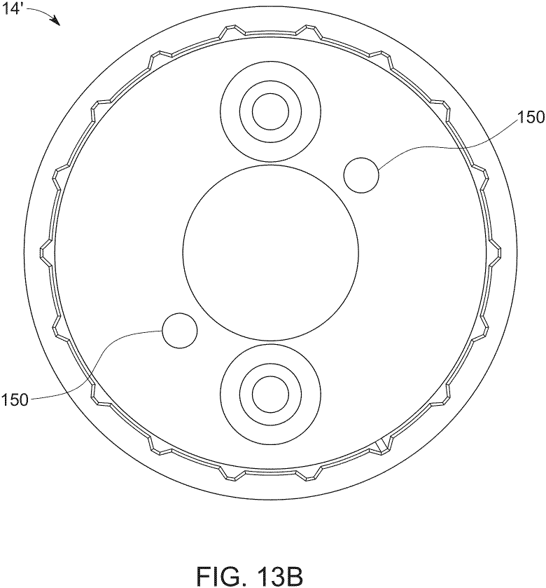

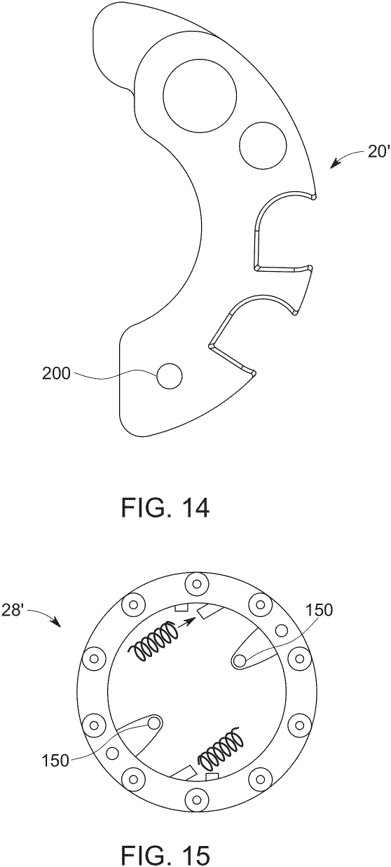

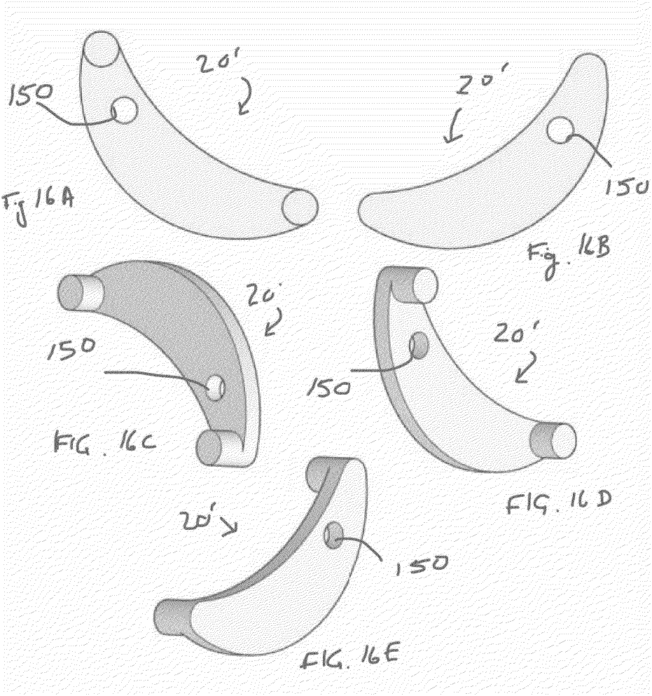

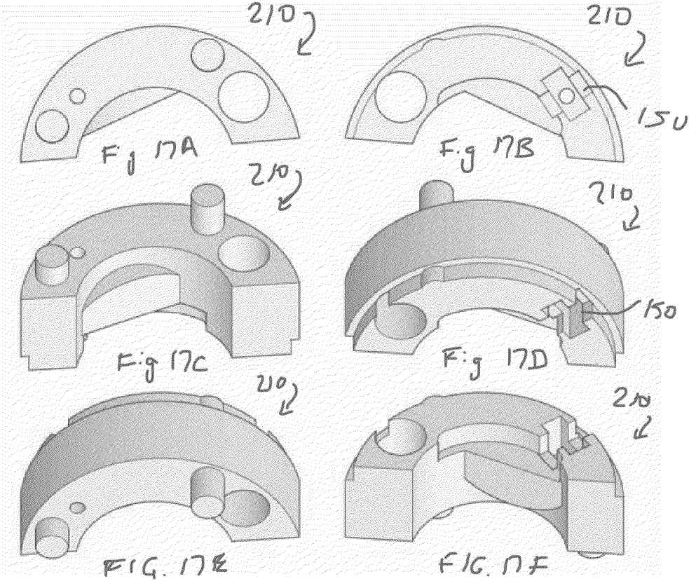

Turning to FIGS. 13A-17E, it will be understood that the present teachings may be adapted to alternatively or additionally include magnets for controlling relative rotation. For example, FIGS. 13A and 13B illustrate a modified end cap 14′. FIG. 14 illustrates a modified brake element 20′ in accordance with the present teachings. FIG. 15 is illustrates a modified collar 28′ of the present teachings. FIGS. 16A-16E further illustrate the modified brake element 20′. FIGS. 17A-17E illustrates a magnet housing in accordance with the present teachings

The end cap 14′ includes a pair of cylindrical magnets 150 mounting in holes of the end cap 14′. The magnets 150 may be used in lieu of springs to accomplish free spinning at lower RPM. As shown in FIG. 14, the brake element 20′ may similarly include a cylindrical steel pin 200 mounted in a hole of the brake element 20′. In this adaptation, the magnets 150 are attracted to the steel (or ferrous material) pins in FIGS. 16A-16E and FIGS. 13A and 13B to allow the brake element 20′ to remain disengaged at low RPM. Once the RPM on the roller increases, the centrifugal force will overpower the strength for the magnets 150 attracted to the steel pin 200, allowing the brake element to engage the non-rotating hub. With reference to FIG. 15 and FIGS. 17A-17E, a modified collar 28′ and the magnet housing 210 are illustrated. The modified collar 28′ has been adapted to include four (4) magnets 150. The two (2) inside magnets 150 are installed to be repelling the magnets in FIGS. 17A-17E and the two (2) outside magnets are installed to be attracting the magnets in FIGS. 17A-17E. When the brake elements 20′ with the attached magnet housing 210 (FIGS. 17A-17E) advances to the position where the magnets 150 are located in the collar 28′ the magnets 150 provide additional braking force of the brake element 20′ against the non-rationing hub. This arrangement is particularly useful for the Line Pressure Reduction Option that can be added to the speed controlling braking mechanism.

The foregoing description of the embodiment(s) has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure. One or more example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

What is claimed is:

1. A speed limited rotational member comprising:
a first member;
a second member rotatable relative to the first member; and
first and second brake elements pivotally mounted to the first member for both pivoting between a first position spaced apart from a cooperating surface of the second member and a second position engaging the cooperating surface of the second member for generating friction to reduce a rotational speed of the rotational member; and
at least one linkage connecting the first and second brake elements.

2. The speed limited rotational member of claim 1, wherein the at least one linkage includes first and second linkages.

3. The speed limited rotational member of claim 1, wherein the second member is a cylindrical hub.

4. The speed limited rotational member of claim 1 further comprising a spring associated with each brake element, the spring predetermining the rotational speed of the rotational member at which friction between the first and second elements commences.

5. The speed limited rotational member of claim 1, wherein each brake element includes a friction member carried at a radially outer surface thereof for engaging the cooperating surface of the second member.

6. The speed limited rotational member of claim 1, wherein each brake element is arch-shaped with a first end pivotally coupled to the first member.

7. The speed limited wheel of claim 1, wherein the first and second brake elements have a common mass.

8. The speed limited rotational member of claim 1, in combination with a conveyor system.

9. The speed limited rotational member of claim 1, in combination with a wheel.

10. The speed limited rotational member of claim 1, further comprising means for creating a backspin to one of the hub and an end cap.

11. The speed limited rotational member of claim 10, wherein the means for creating a backspin includes a down pressure reduction assembly including a down pressure reduction component having main body portion with a central opening rotatably receiving the shaft.

12. The speed limited rotational member of claim 11, wherein the main body portion defines a plurality of radially extending holes and the down pressure reduction component further includes a corresponding plurality of friction element and a corresponding plurality of springs, a respective spring and friction element disposed in each of the radially extending holes such that the springs radially bias the friction elements outward into constant contact with the inside of the hub.

13. A roller assembly for a conveyor system, the roller assembly comprising:
a shaft;
a first end cap rotatably carried on the shaft;
a hub connected to the shaft;
a puck disposed in a recess of one of the first end cap and the hub, the puck rotatable relative to one of the first end cap and the hub, the puck having a central opening through which the shaft passes, the central opening allowing the puck to rotate relative to the shaft;
first and second brake elements pivotably mounted to the puck, the first and second brake elements both pivotal between a first position and a second position;
the hub circumferentially surrounding the first and second brake elements; and
at least one linkage connecting the first and second brake element;
wherein in the first positions the brake elements allow free rotation of the end cap about the shaft and in the second positions, the brake elements frictionally engage the hub to reduce a rotational speed.

14. The speed limited rotational member of claim 13, further comprising means for creating a backspin to the one of the first end cap and or the hub.

15. The speed limited rotational member of claim 14, wherein the means for creating a backspin includes a down pressure reduction assembly cooperatively defined by a down pressure reduction component, the puck and a collar, the down pressure reduction component including a main body portion with a central opening receiving the shaft.

16. The speed limited rotational member of claim 15, wherein the main body portion defines a plurality of radially extending holes and the down pressure reduction component further includes a corresponding plurality of friction element and a corresponding plurality of springs, a respective spring and friction element disposed in each of the radially extending holes such that the springs radially bias the friction elements outward into constant contact with the inside of the hub.

17. A method of reducing a rotational speed of a rotational member, the method comprising:
providing a cylindrical hub;
pivotally mounting first and second brake elements to an element;
linking the first and second brake elements with at least one linkage; and
pivoting each brake element between a first position spaced apart from the hub and a second position engaging the hub to generate friction to reduce a rotational speed of the rotational member.
